(19) United States
(12) Patent Application Publication
(10) Pub. No.: US 2019/0282435 A1
(43) Pub. Date: Sep. 19, 2019

(54) Massage Pad

(71) Applicant: Meng Chieh Lin, Fengyuan Dist. (TW)

(72) Inventor: Meng Chieh Lin, Fengyuan Dist. (TW)

(21) Appl. No.: 16/108,222

(22) Filed: Aug. 22, 2018

(30) Foreign Application Priority Data
Mar. 19, 2018 (TW) 107109267

(51) Int. Cl. A61H 7/00; A43B 7/14

(52) U.S. Cl. CPC A61H 7/001; A61H 2205/125; A43B 7/146

(57) ABSTRACT

A massage pad includes a body having a certain thickness, and the body includes a first face and a second face which is located opposite to the first face. The first face has multiple protrusions integrally formed thereon. Each protrusion has a root portion and a rounded portion which is integrally formed with the root portion. The root portion of each protrusion extends from the first face of the body. The diameter of each rounded portion is between 2 mm to 6 mm. The deformation rate of the rounded portion is less than that of the root portion of each protrusion so as to maintain the ball shape to provide better massage feature.

### BACKGROUND OF THE INVENTION

### 1. Fields of the Invention

The present invention relates to a massage pad for yoga and for insoles of shoes.

### 2. Descriptions of Related Art

There are many different massage devices designed for different ways of use, such as yoga pads, massage cylinders or shoe insoles. These products are made resilient and anti-slip material such as rubber or foam material. One of the products known to applicant is a massage cylinder which has a soft outer layer and multiple cone-shaped protrusions protrude from the soft outer layer. The cone-shaped protrusions provide massage features to the users. However, the cone-shaped protrusions tend to be deformed significantly during use, so that the massage and anti-slip functions are reduced. If the manufacturers increase the density of the cone-shaped protrusions to avoid deformation, the tips of the cone-shaped protrusions make the users uncomfortable.

Therefore, the present invention is intended to provide a massage pad that has protrusions extending from the surface thereof, and the protrusions are made to eliminate the drawbacks mentioned above.

### SUMMARY OF THE INVENTION

The present invention relates to a massage pad and comprises a body having a first face and a second face which is located opposite to the first face. The first face has multiple protrusions integrally formed thereon, and each protrusion has a root portion and a rounded portion which is integrally formed with the root portion. The root portion of each protrusion extends from the first face of the body. The diameter of each rounded portion is between 2 mm to 6 mm. The deformation rate of the rounded portion is less than that of the root portion of each protrusion.

Preferably, each protrusion is a conical protrusion, and the diameter of each of the protrusions is gradually reduced from the root portion toward the rounded portion.

Preferably, the maximum width of the root portion is not less than 2.2 times of the diameter of the rounded portion.

Preferably, the root portion includes a flat surface formed on the top thereof when the diameter of the rounded portion is between 2 mm to 6 mm. The diameter of the flat surface is larger than the diameter of the rounded portion.

Preferably, the body is a shoe insole.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the massage pad of the present invention;

FIG. 2 is an enlarged view to show a portion of the massage pad of the present invention;

FIG. 3 is a side view to show the protrusions of the massage pad of the present invention;

FIG. 4 is an enlarged view to show a portion of the second embodiment of the massage pad of the present invention;

FIG. 5 is a side view to show the protrusions of the second embodiment of the massage pad of the present invention, and

FIG. 6 shows that the massage pad of the present invention can be used as a shoe insole.

### DETAILED DESCRIPTION OF THE PREFERRED EMBODIMENT

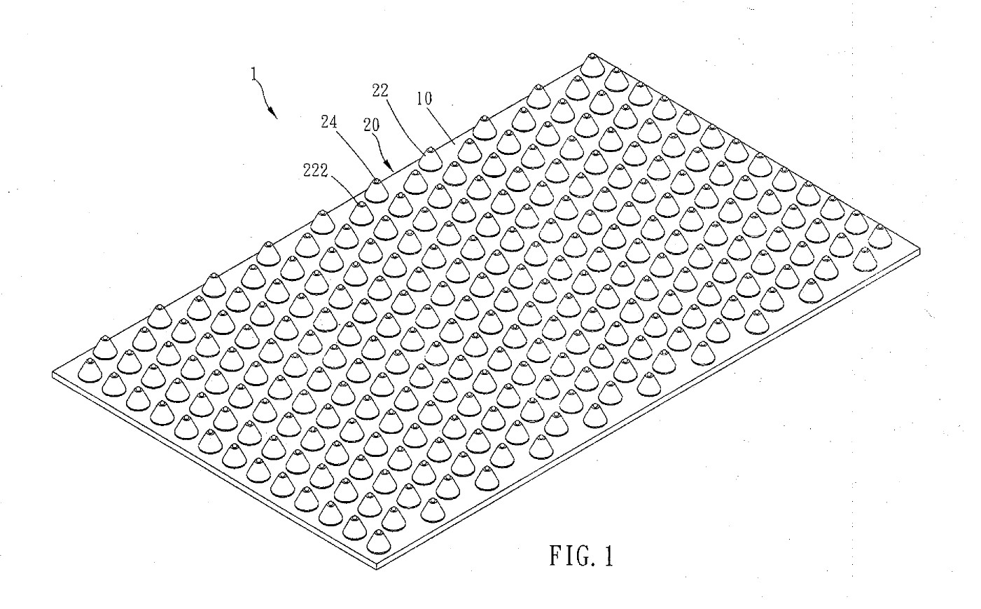

Referring to FIGS. 1 to 5, the massage pad 1 of the present invention is a rectangular pad and comprises a body 10 having a first face 12 and a second face 14 which is located opposite to the first face 12. The body 1 includes a certain thickness. The massage pad 1 is made of Ethylene Vinyl Acetate, Polyvinyl Chloride, Polyethylene Terephthalate, Polyurethane, Polypropylene or Polyethylene. The first face 12 includes multiple protrusions 20 integrally formed thereon by way of foaming, and each protrusion 20 has a root portion 22 and a rounded portion 24 which is integrally formed with the root portion 22. The root portion 22 of each protrusion 20 extends from the first face 12 of the body 10. The diameter of each rounded portion 24 is between 2 mm to 6 mm, and the deformation rate of the rounded portion 24 is less than that of the root portion 22 of each protrusion 20.

Preferably, the protrusions are also formed on the second face 14 of the body 10. Alternatively, the second face 14 of the body 10 is an anti-slip surface.

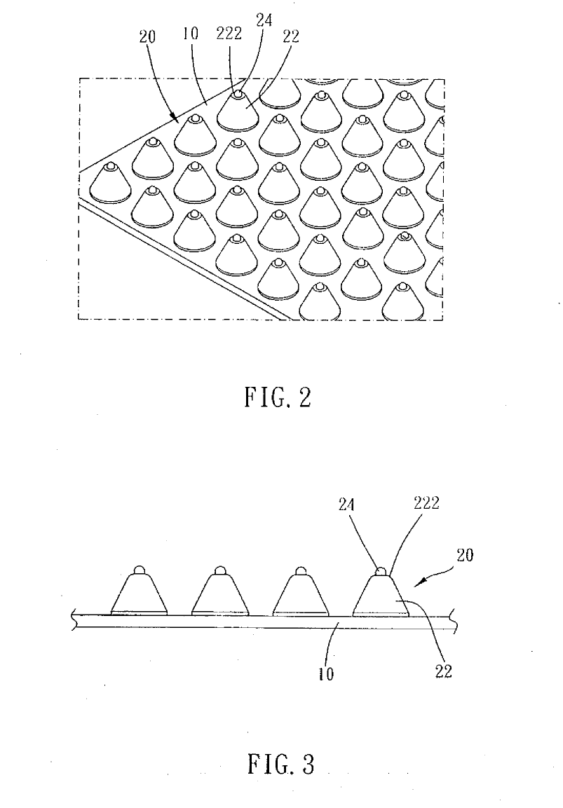

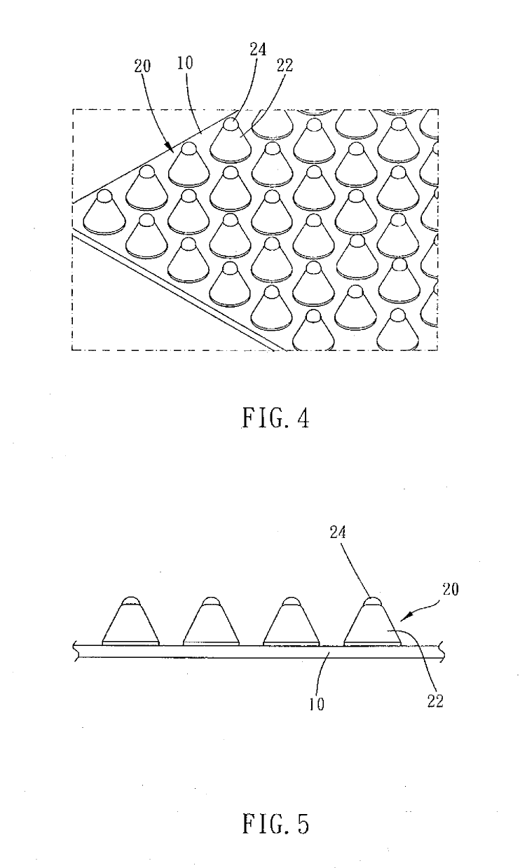

As shown in FIGS. 2 and 3, the root portion 22 includes a flat surface 222 formed on the top thereof when the diameter of the rounded portion 24 is 3 mm (between 2 mm to 6 mm). The diameter of the flat surface 222 is larger than the diameter of the rounded portion 24. As shown in FIGS. 4 and 5, when the diameter of the rounded portion 24 is 6 mm, the rounded portion is a semi-sphere. Each protrusion 20 is a conical protrusion, and the diameter of each of the protrusions 20 is gradually reduced from the root portion 22 toward the rounded portion 24. The maximum width of the root portion 22 is not less than 2.2 times of the diameter of the rounded portion 24.

It is noted that the protrusions 20 are integrally formed on the body 10, and the diameter of the rounded portions 24 cannot less than 2 mm, and larger than 6 mm. Within this range, the protrusions 24 provide comfortable massage features to the users. If the diameter of the rounded portions 24 is less than 2 mm, the pressure applied to the users may cause uncomfortable. When the diameter of the rounded portions 24 is larger than 6 mm, the diameter of the rounded portions 24 is larger than the diameter of the fat surfaces 222, this will cause too much deformation to the protrusions 24 and therefore affects the massage features. The maximum width of the root portion 22 is not less than 2.2 times of the diameter of the rounded portion 24, so that the root portion 22 can be deformed to provide cushion feature to the users, and the rounded portions 24 is deformed less than that of the root portions 22 so as to massage the users.

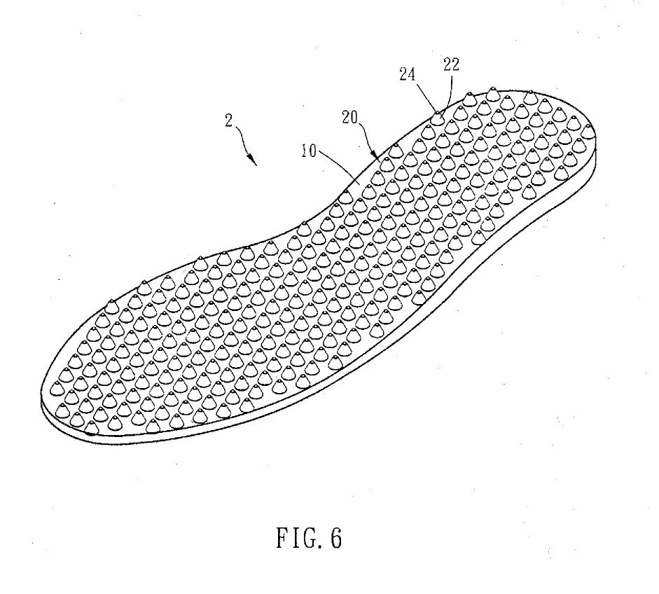

As shown in FIG. 6, yet another use of the massage pad 1 of the present invention is to cut the body 10 to fit a shoe so as to perform as a show insole 2.

While we have shown and described the embodiment in accordance with the present invention, it should be clear to those skilled in the art that further embodiments may be made without departing from the scope of the present invention.

What is claimed is:

1. A massage pad comprising:
a body having a first face and a second face which is located opposite to the first face, the first face having multiple protrusions integrally formed thereon, each protrusion having a root portion and a rounded portion which is integrally formed with the root portion, the root portion of each protrusion extending from the first face of the body, a diameter of each rounded portion being between 2 mm to 6 mm, a deformation rate of the rounded portion being less than that of the root portion of each protrusion.

2. The massage pad as claimed in claim 1, wherein each protrusion is a conical protrusion, and a diameter of each of the protrusions is reduced from the root portion toward the rounded portion.

3. The a massage pad s claimed in claim 1, wherein a maximum width of the root portion is not less than 2.2 times of a diameter of the rounded portion.

4. The massage pad as claimed in claim 3, wherein the root portion includes a flat surface formed on a top thereof when the diameter of the rounded portion is between 2 mm to 6 mm, a diameter of the flat surface is larger than the diameter of the rounded portion.

5. The massage pad as claimed in claim 1, wherein the body is a shoe insole.
